(19) United States
(12) Patent Application Publication
(10) Pub. No.: US 2016/0341118 A1
(43) Pub. Date: Nov. 24, 2016

(54) VARIABLE COMPRESSION RATIO INTERNAL COMBUSTION ENGINE

(71) Applicant: TOYOTA JIDOSHA KABUSHIKI KAISHA, Toyota-shi (JP)

(72) Inventors: Yoshiro KAMO, Ashigarakami-gun (JP); Shuichi EZAKI, Susono-shi (JP)

(73) Assignee: TOYOTA JIDOSHA KABUSHIKI KAISHA, Toyota-shi (JP)

(21) Appl. No.: 15/160,161

(22) Filed: May 20, 2016

(30) Foreign Application Priority Data
May 22, 2015 (JP) 2015-104882

(51) Int. Cl. F02B 75/04; F02D 15/02

(52) U.S. Cl. CPC F02B 75/045; F02D 15/02

(57) ABSTRACT

The internal combustion engine comprises a cylinder, a piston and a connecting rod. The connecting rod comprises a connecting rod body and an eccentric member. The eccentric member is configured so that an axis of the piston pin receiving opening becomes offset from a turning axis of the eccentric member and is configured so as to make the piston ascend with respect to the connecting rod body by turning in one direction and to make the piston descend with respect to the connecting rod body by turning in the other direction. The internal combustion engine further comprises a turning control means for controlling turning of the eccentric member. The turning control means makes an engine speed a reference speed or more when making the eccentric member turn. The reference speed is higher than an idling speed when not making the eccentric member turn.

### CROSS-REFERENCE TO RELATED APPLICATION

The present application claims priority to Japanese Patent Application No. 2015-104882 filed on May 22, 2015, which is incorporated herein by reference in its entirety.

### TECHNICAL FIELD

The present invention relates to a variable compression ratio internal combustion engine able to be changed in a mechanical compression ratio.

### BACKGROUND ART

Known in the past, an internal combustion engine which is provided with a variable compression ratio mechanism able to change the mechanical compression ratio of the internal combustion engine. As such a variable compression ratio mechanism, various mechanisms have been proposed. Among them, one changing an effective length of a connecting rod used in the internal combustion engine may be mentioned (for example, PLT 1). Here, the “effective length of the connecting rod” means the distance from a center of a crank receiving opening receiving a crankpin and a center of a piston pin receiving opening receiving a piston pin. Therefore, if the effective length of the connecting rod becomes longer, the volume of the combustion chamber when the piston is at compression top dead center becomes smaller and therefore the mechanical compression ratio increases. On the other hand, if the effective length of the connecting rod becomes smaller, the volume of the combustion chamber when the piston is at compression top dead center becomes larger and therefore the mechanical compression ratio falls.

As the variable length connecting rod able to be changed in effective length, one providing a small diameter end part of a connecting rod body with an eccentric member (eccentric arm or eccentric sleeve) able to turn with respect to the connecting rod body has been known (for example, PLT 1). The eccentric member has a piston pin receiving opening receiving a piston pin. This piston pin receiving opening is provided eccentrically with respect to a turning axis of the eccentric member. For this reason, if an inertial force due to reciprocation of the piston acts on the piston pin, the eccentric member turns.

In such a variable length connecting rod, if changing the turned position of the eccentric member, it is possible to change the effective length of the connecting rod along with this. Specifically, the eccentric member turns in one direction to thereby make the effective length of the connecting rod longer. As a result of this, the piston ascends with respect to the connecting rod body and the mechanical compression ratio is switched from a low compression ratio to a high compression ratio. On the other hand, the eccentric member turns in the other direction to thereby make the effective length of the connecting rod shorter. As a result of this, the piston descends with respect to the connecting rod body and the mechanical compression ratio is switched from a high compression ratio to a low compression ratio. Therefore, in a variable compression ratio internal combustion engine provided with such a variable length connecting rod, it is possible to switch the mechanical compression ratio between the low compression ratio and the high compression ratio.

### CITATION LIST

### Patent Literature

PLT 1. Japanese Patent Publication No. 2011-196549A
PLT 2. Japanese Patent Publication No. 5-209585A
PLT 3. Japanese Patent Publication No. 2012-229643A

### SUMMARY OF INVENTION

### Technical Problem

However, the inertial force due to reciprocation of the piston is proportional to the square of the engine speed of the internal combustion engine. For this reason, in the low speed region of the internal combustion engine, a sufficient inertial force cannot be obtained and the response when switching the mechanical compression ratio deteriorates.

Therefore, in consideration of the above problems, an object of the present invention is to improve the response when switching the mechanical compression ratio in a variable compression ratio internal combustion engine comprising a variable length connecting rod.

### Solution to Problem

In order to solve the above problem, in a first invention, there is provided A variable compression ratio internal combustion engine able to change a mechanical compression ratio, comprising a cylinder, a piston reciprocating inside the cylinder, and a connecting rod connected with the piston through a piston pin, wherein the connecting rod comprises a connecting rod body having a large diameter end part provided with a crank receiving opening receiving a crankpin and a small diameter end part positioned at the piston side at the opposite side from the large diameter end part, and an eccentric member having a piston pin receiving opening receiving the piston pin and attached to the small diameter end part to be able to turn, the eccentric member is configured so that an axis of the piston pin receiving opening becomes offset from a turning axis of the eccentric member and is configured so as to make the piston ascend with respect to the connecting rod body by turning in one direction and to make the piston descend with respect to the connecting rod body by turning in the other direction, and the variable compression ratio internal combustion engine further comprises a turning control means for controlling turning of the eccentric member, the turning control means makes an engine speed a reference speed or more when making the eccentric member turn, and the reference speed being higher than an idling speed when not making the eccentric member turn.

In a second invention, if the eccentric member is in a state turned to the other direction before startup of the variable compression ratio internal combustion engine, and the turning control means makes the engine speed in the idling state rise to the reference speed or more when making the eccentric member turn to the one direction right after startup of the variable compression ratio internal combustion engine, in the first invention.

In a third invention, if it is predicted based on a state before startup of the variable compression ratio internal combustion engine that knocking would occur if making the eccentric member turn to the one direction to thereby raise the mechanical compression ratio, the turning control means does not allow the eccentric member to turn to the one direction right after startup of the variable compression ratio internal combustion engine, in the second invention.

In a fourth invention, the connecting rod further comprises a hydraulic cylinder provided at the connecting rod body and supplied with hydraulic oil, and a hydraulic piston sliding inside the hydraulic cylinder, the hydraulic piston is configured to ascend in the hydraulic cylinder when the eccentric member turns to the one direction and to descend in the hydraulic cylinder when the eccentric member turns in the other direction, and the reference speed is made higher when an oil temperature of the hydraulic oil is relatively low compared with when the oil temperature is relatively high, in any one of the first to third inventions.

In a fifth invention, the variable compression ratio internal combustion engine is mounted in a vehicle comprising a continuously variable transmission, the turning control means makes an engine speed rise to the reference speed or more when making the eccentric member turn during operation of the vehicle and the engine speed is less than the reference speed, and the continuously variable transmission is made to change a speed ratio along with the rise in the engine speed so as to maintain the speed of the vehicle, in any one of the first to fourth inventions.

### Advantageous Effects of Invention

According to the present invention, it is possible to improve the response when switching the mechanical compression ratio in a variable compression ratio internal combustion engine comprising a variable length connecting rod.

### BRIEF DESCRIPTION OF DRAWINGS

FIG. 1 is a schematic side cross-sectional view of a variable compression ratio internal combustion engine.

FIG. 2 is a perspective view schematically showing a variable length connecting rod according to the present invention.

FIG. 3 is a cross-sectional side view schematically showing a variable length connecting rod and piston according to the present invention.

FIG. 4 is a schematic disassembled perspective view of a vicinity of a small diameter end part of a connecting rod body.

FIG. 5 is a schematic disassembled perspective view of a vicinity of a small diameter end part of a connecting rod body.

FIG. 6(A) and FIG. 6(B) are cross-sectional side views schematically showing a variable length connecting rod and piston according to the present invention.

FIG. 7 is a cross-sectional side view of a connecting rod enlarging the region in which a flow direction switching mechanism is provided.

FIG. 8(A) and FIG. 8(B) are cross-sectional views of a connecting rod along VIII-VIII and IX-IX of FIG. 7.

FIG. 9 is a schematic view explaining the operation of a flow direction switching mechanism when oil pressure is supplied from an oil pressure supply source to switching pins.

FIG. 10 is a schematic view explaining the operation of a flow direction switching mechanism when oil pressure is not supplied from an oil pressure feed source to switching pins.

FIG. 11 is a time chart of a demanded mechanical compression ratio, mechanical compression ratio, and engine speed in the case where switching of a mechanical compression ratio is demanded right after startup of the internal combustion engine.

FIG. 12 is a flow chart showing a control routine of compression ratio switching processing at the time of startup.

FIG. 13 is a time chart of a demanded mechanical compression ratio, mechanical compression ratio, and engine speed in the case where switching of a mechanical compression ratio is demanded during operation of a vehicle.

FIG. 14 is a flow chart showing a control routine of processing for switching a compression ratio at the time of operation.

### DESCRIPTION OF EMBODIMENTS

Below, referring to the drawings, embodiments of the present invention will be explained in detail. Note that, in the following explanation, similar component elements are assigned the same reference notations.

### First Embodiment

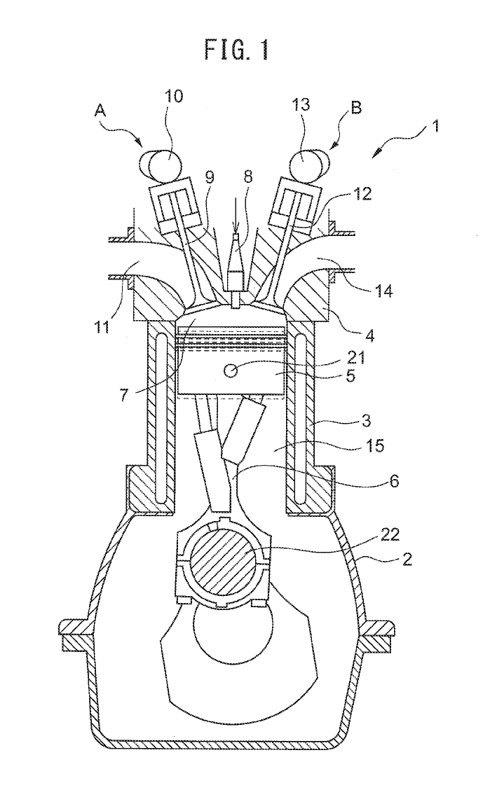

First, referring to FIGS. 1-12, a first embodiment of the present invention will be explained.

<Variable Compression Ratio Internal Combustion Engine>

FIG. 1 is a schematic side cross-sectional view of a variable compression ratio internal combustion engine according to the present invention. Referring to FIG. 1, 1 indicates an internal combustion engine. The internal combustion engine 1 comprises a crankshaft case 2, cylinder block 3, cylinder head 4, pistons 5, variable length connecting rods 6, combustion chambers 7, spark plugs 8 arranged at the center parts of top surfaces of the combustion chambers 7, intake valves 9, an intake camshaft 10, intake ports 11, exhaust valves 12, an exhaust camshaft 13, and exhaust ports 14. The cylinder block 3 forms cylinders 15. The pistons 5 reciprocate inside the cylinders 15. Further, the internal combustion engine 1 further comprises a variable valve timing mechanism A able to control the opening timing and closing timing of the intake valves 9, and a variable valve timing mechanism B able to control the opening timing and closing timing of the exhaust valves 12.

The variable length connecting rod 6 is connected at a small diameter end part thereof by a piston pin 21 to the piston 5, and is connected at a large diameter end part thereof to a crank pin 22 of the crankshaft. The variable length connecting rod 6, as explained later, can change the distance from the axis of the piston pin 21 to the axis of the crank pin 22, that is, the effective length.

If the effective length of the variable length connecting rod 6 becomes longer, the length from the crank pin 22 to the piston pin 21 is longer, and therefore as shown by the solid line in the figure, the volume of the combustion chamber 7 when the piston 5 is at top dead center is smaller. On the other hand, even if the effective length of the variable length connecting rod 6 changes, the stroke length of the piston 5 reciprocating in the cylinder does not change. Therefore, at this time, the mechanical compression ratio at the internal combustion engine 1 is larger.

On the other hand, if the effective length of the variable length connecting rod 6 is shorter, the length from the crank pin 22 to the piston pin 21 is shorter, and therefore as shown by the broken line in the figure, the volume of the combustion chamber when the piston 5 is at top dead center is larger. However, as explained above, the stroke length of the piston 5 is constant. Therefore, at this time, the mechanical compression ratio at the internal combustion engine 1 is smaller.

<Configuration of Variable Length Connecting Rod>

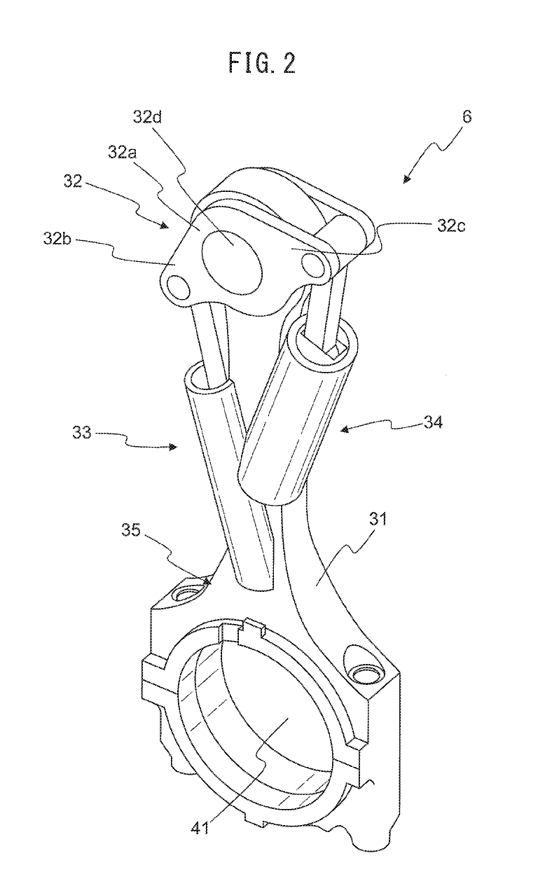

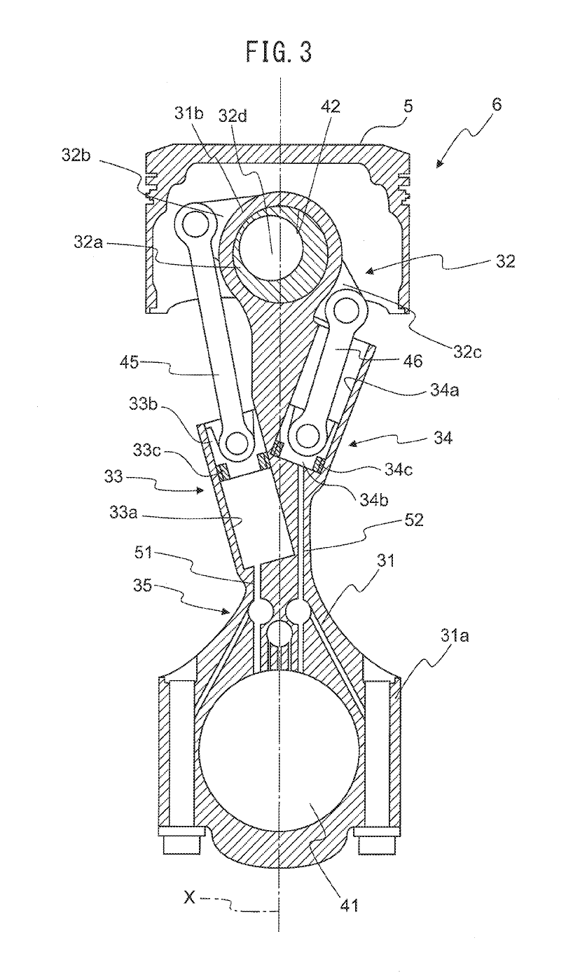

FIG. 2 is a perspective view which schematically shows the variable length connecting rod 6 according to the present invention, while FIG. 3 is a cross-sectional side view which schematically shows the variable length connecting rod 6 according to the present invention. As shown in FIG. 2 and FIG. 3, the variable length connecting rod 6 comprises a connecting rod body 31, an eccentric member 32 which is attached to the connecting rod body 31 to be able to turn, a first piston mechanism 33 and a second piston mechanism 34 which are provided at the connecting rod body 31, and a flow direction switching mechanism 35 which switches the flow of hydraulic oil to these piston mechanisms 33 and 34.

First, the connecting rod body 31 will be explained. The connecting rod body 31 has at one end a crank pin receiving opening 41 which receives the crank pin 22 of the crankshaft, and has at the other end a sleeve receiving opening 42 which receives a sleeve of the later explained eccentric member 32. The crank pin receiving opening 41 is larger than the sleeve receiving opening 42, and therefore the end of the connecting rod body 31 positioned at the side where the crank pin receiving opening 41 is provided (the crankshaft side), will be called a large diameter end part 31a, while the end of the connecting rod body 31 positioned at the side where the sleeve receiving opening 42 is provided (the piston side), will be called a small diameter end part 31b.

Note that, in this Description, an axis X extending between a center axis of the crank pin receiving opening 41 (that is, the axis of the crank pin 22 received in the crank pin receiving opening 41) and a center axis of the sleeve receiving opening 42 (that is, the axis of the sleeve received in the sleeve receiving opening 42) (FIG. 3), that is, the line passing through the center of the connecting rod body 31, will be called the “axis of the connecting rod 6”. Further, the length of the connecting rod in the direction perpendicular to the axis X of the connecting rod 6 and perpendicular to the center axis of the crank pin receiving opening 41 will be called the “width of the connecting rod”. In addition, the length of the connecting rod in the direction parallel to the center axis of the crank pin receiving opening 41 will be called the “thickness of the connecting rod”.

As will be understood from FIG. 2 and FIG. 3, the width of the connecting rod body 31 is narrowest at the intermediate part between the large diameter end part 31a and the small diameter end part 31b. Further, the width of the large diameter end part 31a is larger than the width of the small diameter end part 31b. On the other hand, the thickness of the connecting rod body 31 is substantially a constant thickness, except for the region at which the piston mechanisms 33, 34 are provided.

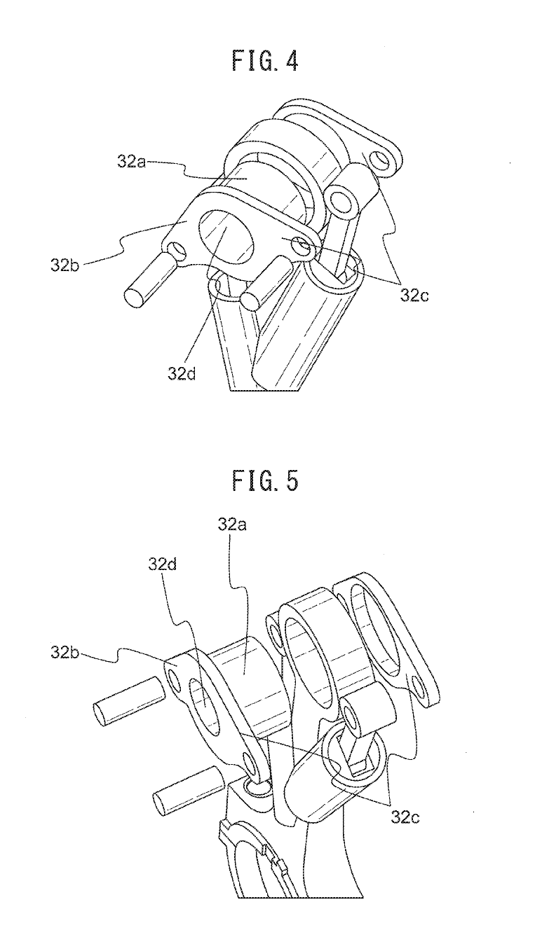

Next, the eccentric member 32 will be explained. FIG. 4 and FIG. 5 are schematic perspective views of the vicinity of the small diameter end part 31b of the connecting rod body 31. In FIG. 4 and FIG. 5, the eccentric member 32 is shown in the disassembled state. Referring to FIG. 2 to FIG. 5, the eccentric member 32 comprises: a cylindrical sleeve 32a received in a sleeve receiving opening 42 formed in the connecting rod body 31; a pair of first arms 32b extending from the sleeve 32a in one direction of the width direction of the connecting rod body 31; and a pair of second arms 32c extending from the sleeve 32a in the other direction of the width direction of the connecting rod body 31 (direction generally opposite to above one direction). The sleeve 32a can turn in the sleeve receiving opening 42, and therefore the eccentric member 32 is attached to be able to turn in the circumferential direction of the small diameter end part 31 with respect to the connecting rod body 31 in the small diameter end part 31b of the connecting rod body 31. The turning axis of the eccentric member 32 matches the center axis of the sleeve receiving opening 42.

Further, the sleeve 32a of the eccentric member 32 has a piston pin receiving opening 32d for receiving a piston pin 21. This piston pin receiving opening 32d is formed in a cylindrical shape. The cylindrical piston pin receiving opening 32d has an axis parallel to the center axis of the cylindrical shape of the sleeve 32a, but is formed so as not to become coaxial with it. Therefore, the axis of the piston pin receiving opening 32d is offset from the center axis of the cylindrical external shape of the sleeve 32a, i.e., the turning axis of the eccentric member 32.

In this way, in the present embodiment, the center axis of the piston pin receiving opening 32d of the sleeve 32a is offset from the turning axis of the eccentric member 32. Therefore, if the eccentric member 32 turns, the position of the piston pin receiving opening 32d in the sleeve receiving opening 42 changes. When the position of the piston pin receiving opening 32d is at the large diameter end part 31a side in the sleeve receiving opening 42, the effective length of the connecting rod 6 becomes shorter. Conversely, when the position of the piston pin receiving opening 32d is at the opposite side to the large diameter end part 31a side in the sleeve receiving opening 42, i.e., the small diameter end part 31b side, the effective length of the connecting rod becomes longer. Therefore, according to the present embodiment, by turning the eccentric member, the effective length of the connecting rod 6 changes.

Next, referring to FIG. 3, the first piston mechanism 33 will be explained. The first piston mechanism 33 has a first cylinder 33a formed in the connecting rod body 31, a first piston 33b sliding in the first cylinder 33a, and a first oil seal 33c sealing the hydraulic oil supplied into the first cylinder 33a. The first cylinder 33a is almost entirely or entirely arranged at the first arm 32b side from the axis X of the connecting rod 6. Further, the first cylinder 33a is arranged slanted by a certain extent of angle with respect to the axis X so that it sticks out further in the width direction of the connecting rod body 31 the closer to the small diameter end part 31b. Further, the first cylinder 33a is communicated with the flow direction switching mechanism 35 through a first piston communicating fluid path 51.

The first piston 33b is connected with the first arm 32b of the eccentric member 32 by a first connecting member 45. The first piston 33b is connected by a pin to the first connecting member 45 to be able to rotate. As shown in FIG. 5, the first arm 32b is connected to the first connecting member 45 by a first pin to be able to rotate, at the end part opposite to the side connected to the sleeve 32a.

The first oil seal 33c has a ring shape and is attached to the circumference of the bottom end part of the first piston 33b. The first oil seal 33c contacts the inner surface of the first cylinder 33a. Frictional force is generated between the first oil seal 33c and the first cylinder 33a.

Next, the second piston mechanism 34 will be explained. The second piston mechanism 34 has a second cylinder 34a formed in the connecting rod body 31, a second piston 34b sliding in the second cylinder 34a, and a second oil seal 34c sealing the hydraulic oil supplied into the second cylinder 34a. The second cylinder 34a is almost entirely or entirely arranged at the second arm 32c side with respect to the axis X of the connecting rod 6. Further, the second cylinder 34a is arranged slanted by a certain extent of angle with respect to the axis X so that it sticks out further in the width direction of the connecting rod body 31 the closer to the small diameter end part 31b. Further, the second cylinder 34a is communicated with the flow direction changing mechanism 35 through a second piston communicating fluid path 52.

The second piston 34b is connected by a second connecting member 46 to the second arm 32c of the eccentric member 32. The second piston 34b is connected by a pin to the second connecting member 46 to be able to rotate. As shown in the FIG. 5, the second arm 32c is connected by a second pin to the second connecting member 46 to be able to rotate at the end part of the opposite side to the side connected to the sleeve 32a.

The second oil seal 34c has a ring shape and is attached to the circumference of the bottom end part of the second piston 34b. The second oil seal 34c contacts the inner surface of the second cylinder 34a. Frictional force is generated between the second oil seal 43c and the second cylinder 34a.

<Operation of Variable Length Connecting Rod>

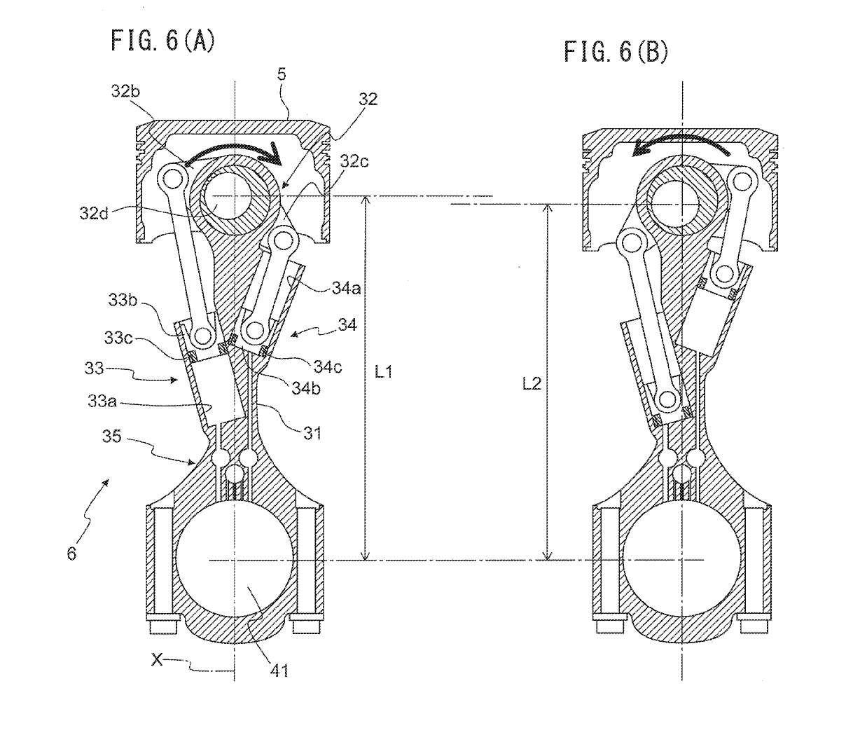

Next, referring to FIG. 6(A) and FIG. 6(B), the operation of the thus configured eccentric member 32, first piston mechanism 33, and second piston mechanism 34 will be explained. FIG. 6(A) shows the state where hydraulic oil is fed to the first cylinder 33a of the first piston mechanism 33 and hydraulic oil is not fed to the second cylinder 34a of the second piston mechanism 34. On the other hand, FIG. 6(B) shows the state where hydraulic oil is not fed to the first cylinder 33a of the first piston mechanism 33 and hydraulic oil is fed to the second cylinder 34a of the second piston mechanism 34.

In this regard, as explained later, the flow direction changing mechanism 35 can be switched between a first state where it prohibits the flow of hydraulic oil from the first cylinder 33a to the second cylinder 34a and permits the flow of hydraulic oil from the second cylinder 34a to the first cylinder 33a, and a second state where it permits the flow of hydraulic oil from the first cylinder 33a to the second cylinder 34a and prohibits the flow of hydraulic oil from the second cylinder 34a to the first cylinder 33a.

When the flow direction changing mechanism 35 is in the first state where it prohibits flow of hydraulic oil from the first cylinder 33a to the second cylinder 34a and permits flow of hydraulic oil from the second cylinder 34a to the first cylinder 33a, as shown in FIG. 6(A), hydraulic oil is fed to the first cylinder 33a and hydraulic oil is discharged from the second cylinder 34a. Therefore, the first piston 33b rises and the first arm 32b of the eccentric member 32 connected to the first piston 33b also rises. On the other hand, the second piston 34b descends and the second arm 32c connected to the second piston 34b also descends. As a result, in the example shown in FIG. 6(A), the eccentric member 32 turns in the arrow direction of the figure and as a result the position of the piston pin receiving opening 32d rises. Therefore, the length between the center of the crank receiving opening 41 and the center of the piston pin receiving opening 32d, that is, the effective length of the connecting rod 6, becomes longer and becomes L1 in the figure. That is, if hydraulic oil is fed to the inside of the first cylinder 33a and hydraulic oil is discharged from the second cylinder 34a, the effective length of the connecting rod 6 becomes longer.

On the other hand, if the flow direction changing mechanism 35 is in the second state where it permits the flow of hydraulic oil from the first cylinder 33a to the second cylinder 34a and prohibits the flow of hydraulic oil from the second cylinder 34a to the first cylinder 33a, as shown in FIG. 6(B), hydraulic oil is fed to the inside of the second cylinder 34a and hydraulic oil is discharged from the first cylinder 33a. Therefore, the second piston 34b rises and the second arm 32c of the eccentric member 32 connected to the second piston 34b also rises. On the other hand, the first piston 33b descends and the first arm 32b connected to the first piston 33b also descends. As a result, in the example shown in FIG. 6(B), the eccentric member 32 turns in the arrow direction in the figure (direction opposite to arrow of FIG. 6(A)) and, as a result, the position of the piston pin receiving opening 32d descends. Therefore, the length between the center of the crank receiving opening 41 and the center of the piston pin receiving opening 32d, that is, the effective length of the connecting rod 6, becomes L2 shorter than L1 in the figure. That is, if hydraulic oil is fed to the inside of the second cylinder 34a and hydraulic oil is discharged from the first cylinder 33a, the effective length of the connecting rod 6 becomes shorter.

Therefore, in the connecting rod 6 according to the present embodiment, as explained above, the effective length of the connecting rod 6 can be switched between L1 and L2, by switching the flow direction changing mechanism 35 between the first state and the second state. As a result, in the internal combustion engine 1 using the connecting rod 6, it is possible to change the mechanical compression ratio.

Here, when the flow direction switching mechanism 35 is in the first state, basically, hydraulic oil is not supplied from the outside. As explained below, the first piston 33b and the second piston 34b move to the positions shown in FIG. 6(A) and the eccentric member 32 turns to the position shown in FIG. 6(A). If an upward inertial force due to reciprocating motion of the piston 5 inside the cylinder 15 of the internal combustion engine 1 acts on the piston pin 21, the first piston 33b rises and the second piston 34b descends. At this time, hydraulic oil is discharged from the second cylinder 34a, hydraulic oil is supplied to the inside of the first cylinder 33a, and the first piston 33b and the second piston 34b move to the positions shown in FIG. 6(A). Further, if an upward inertial force acts on the piston pin 21, the eccentric member 32 turns in one direction (direction of the arrow mark in FIG. 6(A)) (below, referred to as the “high compression ratio direction”) to the position shown in FIG. 6(A). As a result of this, the effective length of the connecting rod 6 becomes longer and the piston 5 rises with respect to the connecting rod body 31. On the other hand, when the piston 5 reciprocates inside the cylinder 15 of the internal combustion engine 1 and a downward inertial force acts on the piston pin 21 or when the air-fuel mixture is burned inside the combustion chamber 7 and a downward force acts on the piston pin 21, the first piston 33b descends and the eccentric member 32 tries to turn in the other direction (direction of the arrow mark in FIG. 6(B)) (below, referred to as the “low compression ratio direction”). However, due to the flow direction switching mechanism 35, the flow of hydraulic oil from the first cylinder 33a to the second cylinder 34a is prohibited, so the hydraulic oil inside the first cylinder 33a does not flow out and accordingly the first piston 33b and eccentric member 32 do not move.

On the other hand, even when the flow direction switching mechanism 35 is in the second state, basically hydraulic oil is not supplied from the outside. As explained below, the eccentric member 32 turns to the position shown by FIG. 6(B), while the first piston 33b and the second piston 34b move to the positions shown in FIG. 6(B). If the downward inertial force due to the reciprocating motion of the piston 5 inside the cylinder 15 of the internal combustion engine 1 and the downward explosive force due to combustion of the air-fuel mixture inside the combustion chamber 7 act on the piston pin 21, the first piston 33b descends and the second piston 34b rises. At this time, hydraulic oil is discharged from the first cylinder 33a, hydraulic oil is supplied to the inside of the second cylinder 34a, and the first piston 33b and the second piston 34b move to the positions shown by FIG. 6(B). Further, if the downward inertial force and explosive force act on the piston pin 21, the eccentric member 32 turns in the low compression ratio direction to the position shown in FIG. 6(B). As a result of this, the effective length of the connecting rod 6 becomes shorter and the piston 5 descends with respect to the connecting rod body 31. On the other hand, when the piston 5 reciprocates inside the cylinder 15 of the internal combustion engine 1 and an upward inertial force acts on the piston pin 21, the second piston 34b tries to descend and the eccentric member 32 tries to turn in the high compression ratio direction. However, due to the flow direction switching mechanism 35, the flow of hydraulic oil from the second cylinder 34a to the first cylinder 33a is prohibited, so the hydraulic oil in the second cylinder 34a does not flow out and therefore the second piston 34b and eccentric member 32 do not move.

Therefore, in the internal combustion engine 1, the mechanical compression ratio is switched by the inertial force from the low compression ratio to the high compression ratio and is switched by the inertial force and explosive force from the high compression ratio to the low compression ratio.

<Configuration of Flow Direction Switching Mechanism>

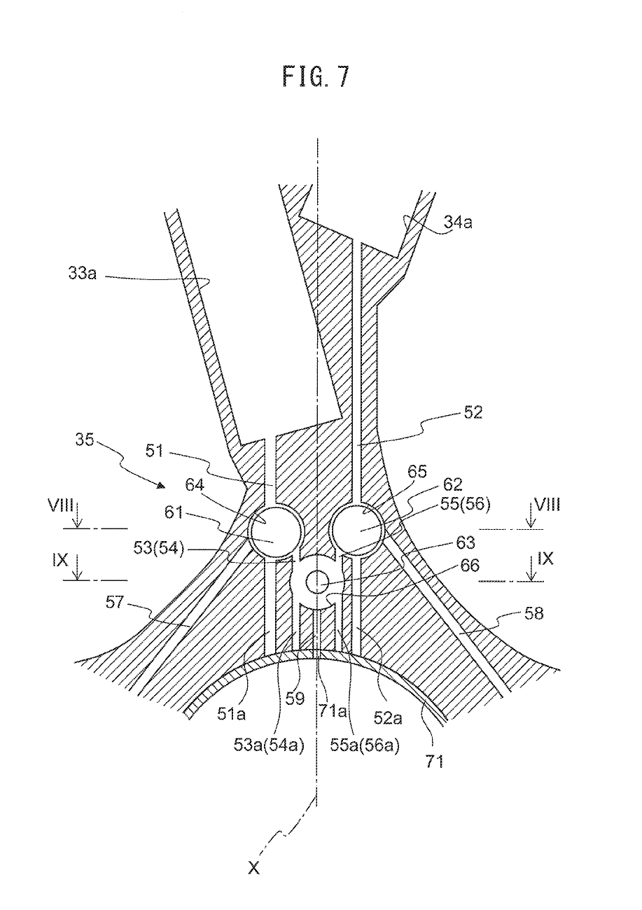

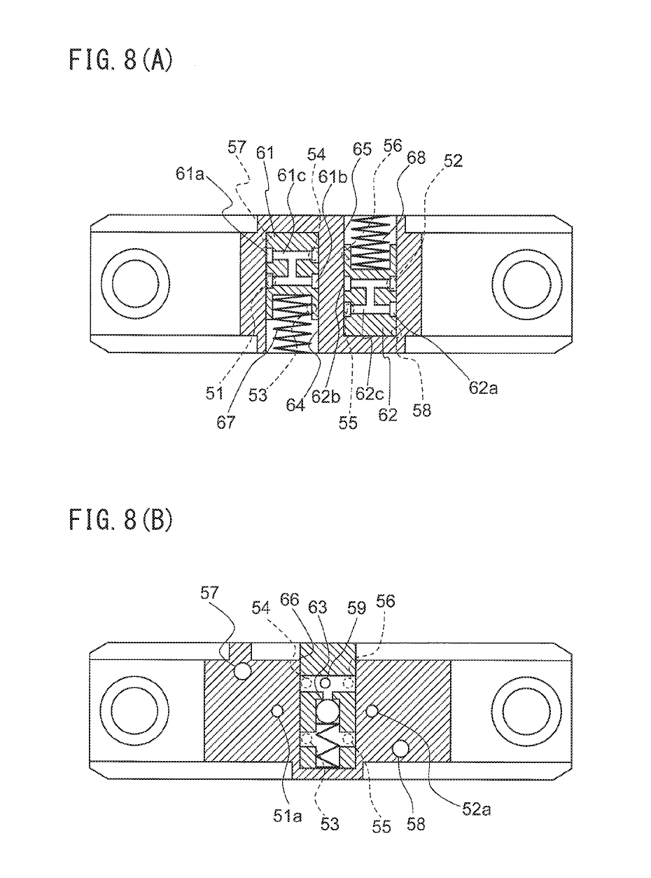

Next, referring to FIG. 7 and FIGS. 8(A) and 8(B), the configuration of the flow direction switching mechanism 35 will be explained. FIG. 7 is a cross-sectional side view of a connecting rod enlarging the region in which the flow direction switching mechanism 35 is provided. FIG. 8(A) is a cross-sectional view of a connecting rod along VIII-VIII of FIG. 7, while FIG. 8(B) is a cross-sectional view of a connecting rod along IX-IX of FIG. 7. As explained above, the flow direction switching mechanism 35 is a mechanism switching between a first state prohibiting the flow of hydraulic oil from the first cylinder 33a to the second cylinder 34a and permitting the flow of hydraulic oil from the second cylinder 34a to the first cylinder 33a, and a second state permitting the flow of hydraulic oil from the first cylinder 33a to the second cylinder 34a and prohibiting the flow of hydraulic oil from the second cylinder 34a to the first cylinder 33a.

The flow direction switching mechanism 35, as shown in FIG. 7, comprises two switching pins 61, 62 and one check valve 63. These two switching pins 61, 62 and check valve 63 are arranged between the first cylinder 33a and the second cylinder 34a, and the crank pin receiving opening 41 in the axis X direction of the connecting rod body 31. Further, the check valve 63 is arranged to the crank pin receiving opening 41 side from the two switching pins 61, 62 in the axis X direction of the connecting rod body 31.

Furthermore, the two switching pins 61, 62 are provided at the both sides of the axis X of the connecting rod body 31 while the check valve 63 is provided on the axis X. Accordingly, it is possible to suppress a drop in the left and right balance of weight of the connecting rod body 31 due to provision of the switching pins 61, 62 and check valve 63 in the connecting rod body 31.

The two switching pins 61, 62 are respectively held in the cylindrical pin holding spaces 64, 65. In the present embodiment, the pin holding spaces 64, 65 are formed so that their axes extend in parallel with the center axis of the crank pin receiving opening 41. The switching pins 61, 62 can slide in the pin holding spaces 64, 65 in the direction in which the pin holding space 64 extends. That is, the switching pins 61, 62 are arranged in the connecting rod body 31 so that their operating directions become parallel to the center axis of the crank pin receiving opening 41.

Further, among the two pin holding spaces 64, 65, the first pin holding space 64 which holds the first switching pin 61, as shown in FIG. 8(A), is formed as a pin holding hole which is opened to one side surface of the connecting rod body 31 and is closed to the other side surface of the connecting rod body 31. In addition, among the two pin holding spaces 64, 65, the second pin holding space 65 which holds the second switching pin 62, as shown in FIG. 8(A), is formed as a pin holding hole which is opened to the other side surface of the connecting rod body 31 and is closed to the one side surface.

The first switching pin 61 has two circumferential grooves 61a, 61b which extend in the circumferential direction. These circumferential grooves 61a, 61b are communicated with each other by a communicating path 61c formed in the first switching pin 61. Further, in the first pin holding space 64. a first biasing spring 67 is held. Due to this first biasing spring 67, the first switching pin 61 is biased in a direction parallel to the center axis of the crank pin receiving opening 41. In particular, in the example shown in FIG. 8(A), the first switching pin 61 is biased toward the closed end of the first pin holding space 64.

Similarly, the second switching pin 62 also has two circumferential grooves 62a, 62b which extend in the circumferential direction. These circumferential groove 62a and 62b are communicated with each other by a communicating path 62c formed in the second switching pin 62. Further, in the second pin holding space 65, a second biasing spring 68 is held. Due to this second biasing spring 68, the second switching pin 62 is biased in a direction parallel to the center axis of the crank pin receiving opening 41. In particular, in the example shown in FIG. 8(A), the second switching pin 62 is biased toward the closed end of the second pin holding space 65.

In addition, the first switching pin 61 and the second switching pin 62 are arranged in opposite directions to each other in directions parallel to the center axis of the crankshaft receiving opening 41. In addition, the second switching pin 62 is biased in the opposite direction to the first switching pin 61. For this reason, in the present embodiment, the operating directions of these first switching pin 61 and second switching pin 62 when these first switching pin and second switching pin 62 are supplied with oil pressure become opposite to each other.

The check valve 63 is held in a cylindrical check valve holding space 66. In the present embodiment, the check valve holding space 66 is formed to extend in parallel with the center axis of the crank pin receiving opening 41. The check valve 63 can move in the check valve holding space 66 in the direction in which the check valve holding space 66 extends. Therefore, the check valve 63 is arranged in the connecting rod body so that its direction of operation is parallel with the center axis of the crank pin receiving opening 41. Further, the check valve holding space 66 is formed as a check valve holding hole which is opened to one side surface of the connecting rod body 31 and is closed to the other side surface of the connecting rod body 31.

The check valve 63 is configured to permit flow from a primary side (in FIG. 8(B), top side) to the secondary side (in FIG. 8(B), bottom side) and to prohibit the flow from the secondary side to the primary side.

The first pin holding space 64 holding the first switching pin 61 is communicated with the first cylinder 33a through the first piston communicating oil path 51. As shown in FIG. 8(A), the first piston communicating oil path 51 is communicated with the first pin holding space 64 near the center of the connecting rod body 31 in the thickness direction. Further, the second pin holding space 65 holding the second switching pin 62 is communicated with the second cylinder 34a through the second piston communicating oil path 52. As shown in FIG. 8(A), the second piston communicating oil path 52 is also communicated with the second pin holding space 65 near the center of the connecting rod body 31 in the thickness direction.

Note that, the first piston communicating oil path 51 and the second piston communicating oil path 52 are formed by cutting from the crankshaft receiving opening 41 by a drill etc. Therefore, at the crankshaft receiving opening 41 sides of the first piston communicating oil path 51 and the second piston communicating oil path 52, the first extended oil path 51a and the second extended oil path 52a coaxial with these piston communicating oil paths 51 and 52 are formed. In other words, the first piston communicating oil path 51 and the second piston communicating oil path 52 are formed so that the crankshaft receiving opening 41 is positioned on their extensions. These first extended oil path 51a and second extended oil path 52a are, for example, closed by bearing metal 71 provided inside the crankshaft receiving opening 41.

The first pin holding space 64 holding the first switching pin 61 is communicated with the check valve holding space 66 through two space communicating oil paths 53 and 54. Among these, the first space communicating oil path 53, as shown in FIG. 8(A), is made to communicate with the first pin holding space 64 and the secondary side of the check valve holding space 66 at one side surface from the center of the connecting rod body 31 in the thickness direction (bottom side in FIG. 8(B)). The other second space communicating oil path 54 is made to communicate with the first pin holding space 64 and the primary side of the check valve holding space 66 at the other side surface from the center of the connecting rod body 31 in the thickness direction (top side in FIG. 8(B)). Further, the first space communicating oil path 53 and the second space communicating oil path 54 are formed so that the interval between the first space communicating oil path 53 and the first piston communicating oil path 51 in the thickness direction of the connecting rod body and the interval between the second space communicating oil path 54 and the first piston communicating oil path 51 in the thickness direction of the connecting rod body become equal to the interval between the circumferential grooves 61a and 61b in the thickness direction of the connecting rod body.

Further, the second pin holding space 65 holding the second switching pin 62 is communicated with the check valve holding space 66 through two space communicating oil paths 55 and 56. Among these, the third space communicating oil path 55, as shown in FIG. 8(A), is made to communicate with the first pin holding space 64 and the secondary side of the check valve holding space 66 at one side surface from the center of the connecting rod body 31 in the thickness direction (bottom side in FIG. 8(B)). The other fourth space communicating oil path 56 is made to communicate with the first pin holding space 64 and the primary side of the check valve holding space 66 at the other side surface from the center of the connecting rod body 31 in the thickness direction (top side in FIG. 8(B)). Further, the third space communicating oil path 55 and the fourth space communicating oil path 56 are formed so that the interval between the third space communicating oil path 55 and the second piston communicating oil path 52 in the thickness direction of the connecting rod body and the interval between the fourth space communicating oil path 56 and the second piston communicating oil path 52 in the thickness direction of the connecting rod body become equal to the interval between the circumferential grooves 62a and 62b in the thickness direction of the connecting rod body.

These space communicating oil paths 53 to 56 are formed by cutting by a drill etc. from the crankshaft receiving opening 41. Therefore, at the crankshaft receiving opening 41 sides of these space communicating oil paths 53 to 56, extended oil paths 53a to 56a coaxial with these space communicating oil paths 53 to 56 are formed. In other words, the space communicating oil paths 53 to 56 are formed so that the crankshaft receiving opening 41 is positioned on their extensions. These extended oil paths 53a to 56a are, for example, closed by the bearing metal 71.

As explained above, the extended oil paths 51a to 56a are both sealed by bearing metal 71. For this reason, only by using bearing metal 71 to assemble the connecting rod 6 to the crankpin 22, it is possible to close these extended oil paths 51a to 56a without separately performing processing for closing these extended oil paths 51a to 56a.

Further, inside the connecting rod body 31, a first control-use oil path 57 for supplying oil pressure to the first switching pin 61 and a second control-use oil path 58 for supplying oil pressure to the second switching pin 62 are formed. The first control-use oil path 57 is communicated with the first pin holding space 64 at the end part at the opposite side to the end part at which the first biasing spring 67 is provided. The second control-use oil path 58 is communicated with the second pin holding space 65 at the end part at the opposite side to the end part at which the second biasing spring 68 is provided. These control-use oil paths 57 and 58 are formed so as to communicate with the crankshaft receiving opening 41 and are communicated with a hydraulic pressure feed source at the outside through oil paths (not shown) formed inside the crankpin 22.

Therefore, when oil pressure is not being supplied from the hydraulic pressure feed source at the outside, the first switching pin 61 and the second switching pin 62 are respectively biased by the first biasing spring 67 and the second biasing spring 68 and, as shown in FIG. 8(A), are positioned at the closed end part sides in the pin holding spaces 64 and 65. On the other hand, when an oil pressure is being supplied from the hydraulic pressure feed source at the outside, the first switching pin 61 and the second switching pin 62 are respectively made to move against the biasing force of the first biasing spring 67 and the second biasing spring 68 and are positioned at the opened end part sides in the pin holding spaces 64 and 65.

Furthermore, inside the connecting rod body 31, a refill-use oil path 59 is formed for refilling hydraulic oil at the primary side of the check valve 63 in the check valve holding space 66 in which the check valve 63 is held. One end part of the refill-use oil path 59 is communicated with the check valve holding space 66 at the primary side of the check valve 63. The other end part of the refill-use oil path 59 is communicated with the crankshaft receiving opening 41. Further, the bearing metal 71 is formed with a through hole 71a matched with the refill-use oil path 59. The refill-use oil path 59 is communicated with the hydraulic oil feed source at the outside through this through hole 71a and an oil path (not shown) formed inside the crankpin 22. Therefore, due to the refill-use oil path 59, the primary side of the check valve 63 is communicated with the hydraulic oil feed source constantly or periodically matched with the rotation of the crankshaft. Note that, in the present embodiment, the hydraulic oil feed source is a lubricating oil feed source supplying lubricating oil to the connecting rod 6, etc.

<Operation of Flow Direction Switching Mechanism>

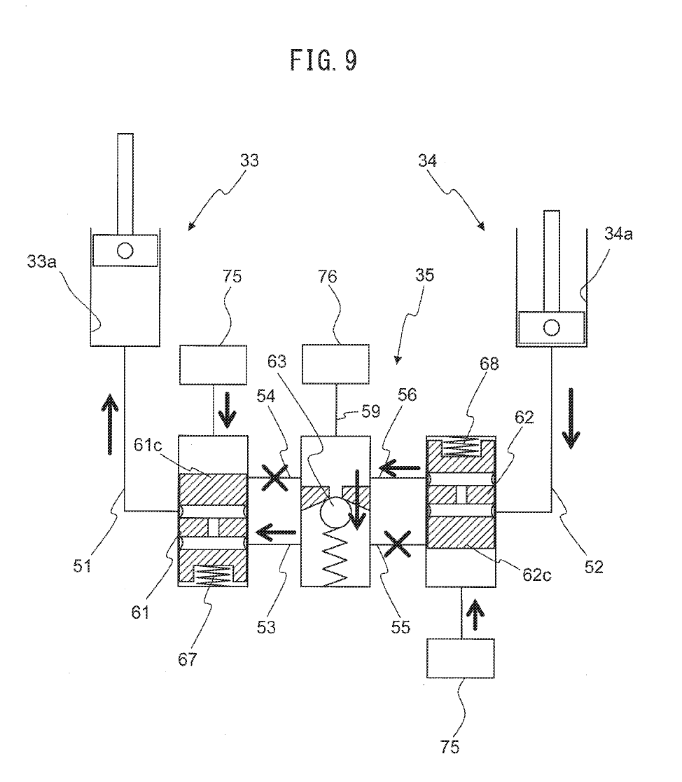

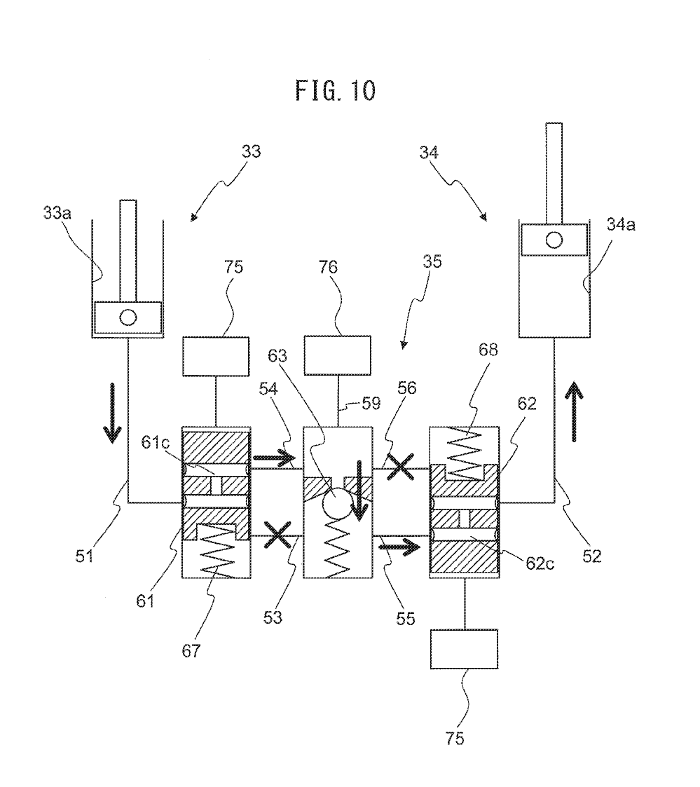

Next, referring to FIG. 9 and FIG. 10, the operation of the flow direction switching mechanism 35 will be explained. FIG. 9 is a schematic view explaining the operation of the flow direction switching mechanism 35 when an oil pressure is supplied from the hydraulic pressure feed source 75 to the switching pins 61 and 62. Further, FIG. 10 is a schematic view explaining the operation of the flow direction switching mechanism 35 when oil pressure is not supplied from the hydraulic pressure feed source 75 to the switching pins 61 and 62. Note that, in FIG. 9 and FIG. 10, the hydraulic pressure feed sources 75 for supplying oil pressure to the first switching pin 61 and the second switching pin 62 are separately drawn, but in the present embodiment, oil pressure is supplied from the same hydraulic pressure feed source.

As shown in FIG. 9, when an oil pressure is supplied from the hydraulic pressure feed source 75, the switching pins 61 and 62 are respectively positioned at the first positions where they move against the biasing forces of the biasing springs 67 and 68. As a result of this, due to the communicating path 61c of the first switching pin 61, the first piston communicating oil path 51 and the first space communicating oil path 53 are communicated, while due to the communicating path 62c of the second switching pin 62, the second piston communicating oil path 52 and the fourth space communicating oil path 56 are communicated. Therefore, the first cylinder 33a is connected to the secondary side of the check valve 63, while the second cylinder 34a is connected to the primary side of the check valve 63.

Here, the check valve 63 is configured to permit the flow of hydraulic oil from the primary side where the second space communicating oil path 54 and fourth space communicating oil path 56 communicate to the secondary side where the first space communicating oil path 53 and third space communicating oil path 55 communicate, and to prohibit the reverse flow. Therefore, in the state shown in FIG. 9, hydraulic oil flows from the fourth space communicating oil path 56 to the first space communicating oil path 53, but hydraulic oil does not flow in reverse.

As a result of this, in the state shown in FIG. 9, the hydraulic oil inside the second cylinder 34a can be supplied to the first cylinder 33a through the oil path in the order of the second piston communicating oil path 52, fourth space communicating oil path 56, first space communicating oil path 53, and first piston communicating oil path 51. However, the hydraulic oil inside the first cylinder 33a cannot be supplied to the second cylinder 34a. Therefore, when a predetermined pressure or more of oil pressure is supplied from the hydraulic pressure feed source 75, the flow direction switching mechanism 35 can be said to be in a first state where it prohibits the flow of hydraulic oil from the first cylinder 33a to the second cylinder 34a and permits the flow of hydraulic oil from the second cylinder 34a to the first cylinder 33a. As a result of this, as explained above, the first piston 33b rises and the second piston 34b descends, so the effective length of the connecting rod 6 becomes long as shown by L1 in FIG. 6(A).

On the other hand, as shown in FIG. 10, when oil pressure is not supplied from the hydraulic pressure feed source 75, the switching pins 61 and 62 are positioned at second positions where they are biased by the biasing springs 67 and 68. As a result of this, due to the communicating path 61c of the first switching pin 61, the first piston communicating oil path 51 communicated with the first piston mechanism 33 and the second space communicating oil path 54 are communicated. In addition, due to the communicating path 62c of the second switching pin 62, the second piston communicating oil path 52 communicating with the second piston mechanism 34 and the third space communicating oil path 55 are made to communicate. Therefore, the first cylinder 33a is connected to the primary side of the check valve 63, while the second cylinder 34a is connected to the secondary side of the check valve 63.

Due to the action of the above-mentioned check valve 63, in the state shown in FIG. 10, the hydraulic oil inside the first cylinder 33a can pass through the oil path in the order of the first piston communicating oil path 51, second space communicating oil path 54, third space communicating oil path 55, and second piston communicating oil path 52 and be supplied to the second cylinder 34a. However, the hydraulic oil inside the second cylinder 34a cannot be supplied to the first cylinder 33a. Therefore, when oil pressure is not being supplied from the hydraulic pressure feed source 75, the flow direction switching mechanism 35 can be said to be in a second state where it permits the flow of hydraulic oil from the first cylinder 33a to the second cylinder 34a and prohibits the flow of hydraulic oil from the second cylinder 34a to the first cylinder 33a. As a result of this, as explained above, the second piston 34b rises and the first piston 33b descends, so the effective length of the connecting rod 6 becomes shorter as shown by L2 in FIG. 6(B).

Further, in the present embodiment, as explained above, hydraulic oil travels back and forth between the first cylinder 33a of the first piston mechanism 33 and the second cylinder 34a of the second piston mechanism 34. For this reason, basically, hydraulic oil does not have to be supplied from the outside of the first piston mechanism 33, second piston mechanism 34, and flow direction switching mechanism 35. However, hydraulic oil may leak to the outside from the oil seals 33c, 34c, etc. provided at these mechanisms 33, 34, and 35. If hydraulic oil leaks in this way, it has to be refilled from the outside.

In the present embodiment, there is the refill-use oil path 59 at the primary side of the check valve 63. Due to this, the primary side of the check valve 63 is constantly or periodically communicated with hydraulic oil feed source 76. Therefore, even if hydraulic oil leaks from the mechanisms 33, 34, 35, etc., the hydraulic oil can be refilled.

Furthermore, in the present embodiment, the flow direction switching mechanism 35 is configured to become a first state where the effective length of the connecting rod 6 becomes long when an oil pressure is supplied from the hydraulic pressure feed source 75 to the switching pins 61 and 62 and to become a second state where the effective length of the connecting rod 6 becomes short when oil pressure is not supplied from the hydraulic pressure feed source 75 to the switching pins 61 and 62. Due to this, for example, when a breakdown at the hydraulic pressure feed source 75 etc. makes it no longer possible to supply oil pressure, it is possible to leave the effective length of the connecting rod 6 short and therefore possible to maintain the mechanical compression ratio low.

In this regard, when the mechanical compression ratio is made high, compared with when the mechanical compression ratio is made low, the distance between the top surface of the piston 5 when the piston 5 is at top dead center and the intake valve 9 and the exhaust valve 12 becomes shorter. For this reason, if the mechanical compression ratio is maintained high when the supply of oil pressure is no longer possible, the piston 5 is liable to collide with the intake valve 9 or the exhaust valve 12. For example, if controlling the variable valve timing mechanism A to advance the opening timing of the intake valve 9 or if controlling the variable valve timing mechanism A to retard the closing timing of the intake valve 9, the piston 5 and the intake valve 9 are liable to collide. However, in the present embodiment, by maintaining the mechanical compression ratio low when oil pressure can no longer be supplied, collision of the piston 5 and the intake valve 9 or the exhaust valve 12 can be prevented.

Further, if the internal combustion engine 1 is stopped in the state where the mechanical compression ratio is made high and the internal combustion engine 1 is restarted in the high temperature state, knocking is liable to occur if the mechanical compression ratio is still maintained high. However, in the present embodiment, when stopping the internal combustion engine 1, oil pressure is not supplied, so the internal combustion engine 1 is restarted in a state where the mechanical compression ratio is made low. For this reason, in the present embodiment, the occurrence of knocking at the time of high temperature restart can be suppressed.

<Problem of Response when Switching Mechanical Compression Ratio>

However, in the low load region where the demanded torque is small, to improve the fuel economy, it is desirable to make the mechanical compression ratio high. Therefore, at the time of restart of the internal combustion engine 1, sometimes it is demanded to quickly switch the mechanical compression ratio from a low compression ratio to a high compression ratio. Further, in a low speed region such as the idling state, sometimes it is demanded to quickly switch the mechanical compression ratio from a low compression ratio to a high compression ratio.

However, as explained above, in the internal combustion engine 1, the mechanical compression ratio is switched from the low compression ratio to the high compression ratio by the inertial force, and is switched from the high compression ratio to the low compression ratio by the inertial force and explosive force. The inertial force is far smaller than the explosive force. For this reason, when switching the mechanical compression ratio from the low compression ratio to the high compression ratio, a sufficient response is hard to obtain. Further, the inertial force is proportional to the square of the engine speed of the internal combustion engine 1, so in the low speed region of the internal combustion engine 1, a sufficient inertial force cannot be obtained and the response further deteriorates.

<Response Improving Means>

Therefore, in the present embodiment, the internal combustion engine 1 further comprises a turning control means for controlling turning of the eccentric member 32 so as to improve the response when switching the mechanical compression ratio. The turning control means can control the flow direction switching mechanism 35 to control the timing of making the eccentric member 32 turn and the turning direction of the eccentric member 32, that is, the timing of switching the mechanical compression ratio and switching direction of the mechanical compression ratio. Further, the turning control means can control the engine speed of the internal combustion engine 1 to thereby control the turning speed of the eccentric member 32, that is, the switching speed of the mechanical compression ratio. Specifically, the turning control means makes the engine speed a reference speed or more when making the eccentric member 32 turn. Note that, the engine speed, for example, can be changed by controlling the opening degree of the throttle valve arranged at the intake passage of the internal combustion engine 1 etc.

The reference speed is made a speed enabling the mechanical compression ratio to be switched from the low compression ratio to the high compression ratio or a speed enabling a sufficient response when switching the mechanical compression ratio from the low compression ratio to the high compression ratio. The reference speed is, for example, made 1550 rpm to 2000 rpm or so and is made higher than the idling speed when not causing the eccentric member 32 to turn (below, referred to as the “normal idling speed”), for example, 1200 rpm to 1500 rpm.

<Time Chart of Switching of Mechanical Compression Ratio Right after Startup of Internal Combustion Engine>

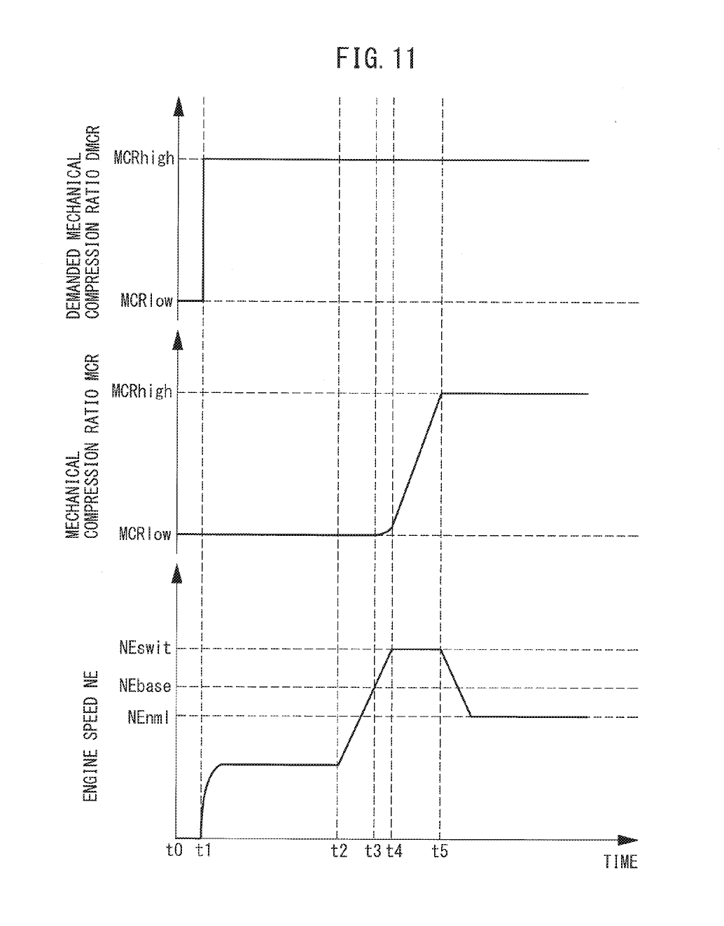

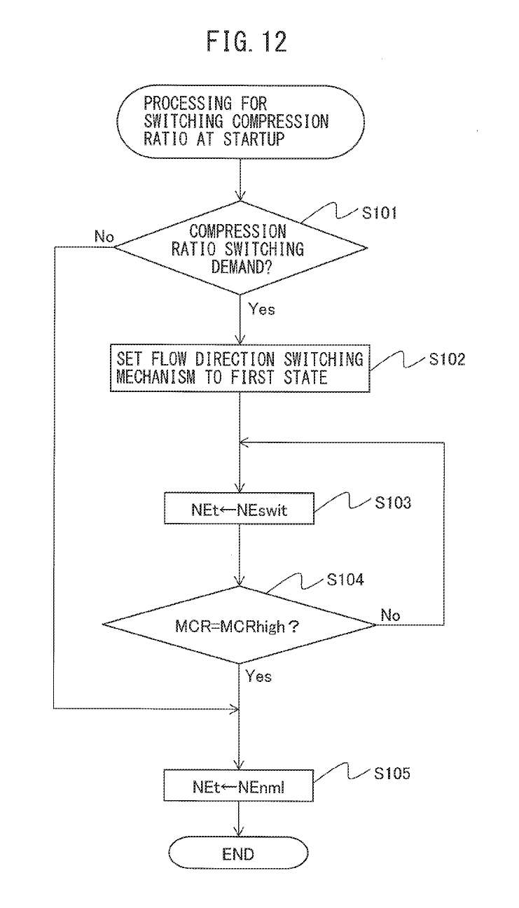

Below, referring to FIG. 11 and FIG. 12, this control will be specifically explained. FIG. 11 is a time chart of the demanded mechanical compression ratio DMCR, mechanical compression ratio MCR (actual mechanical compression ratio), and engine speed NE when switching of the mechanical compression ratio MCR is demanded right after startup of the internal combustion engine 1.

In the example of FIG. 11, at the time t0, the ignition switch of the vehicle in which the internal combustion engine 1 is mounted is turned on. After that, at the time t1, cranking of the internal combustion engine 1 is started and the internal combustion engine 1 is started up. Before startup of the internal combustion engine 1 before the time t1, the mechanical compression ratio MCR was the low compression ratio MCRlow. Therefore, before startup of the internal combustion engine 1, the eccentric member 32 was in a state turned in the low compression ratio direction. After the internal combustion engine 1 starts to be cranked, the engine speed NE rises to a predetermined speed.

At the same time as cranking is started at the time t1, the demanded mechanical compression ratio DMCR is switched from the low compression ratio MClow to the high compression ratio MChigh and accordingly turning of the eccentric member 32 in the high compression ratio direction is demanded. Along with this, at the time t1, oil pressure is supplied from the hydraulic pressure feed source 75 to the switching pins 61 and 62, whereby the flow direction switching mechanism 35 is changed from the second state to the first state. Due to this, the flow of hydraulic oil from the second cylinder 34a to the first cylinder 33a is permitted. For this reason, if the upward inertial force acting on the piston pin 21 becomes larger than a predetermined value due to the rise of the engine speed NE, the eccentric member 32 turns to the high compression ratio direction. However, at the times t1 to t3, the engine speed NE is low, so the eccentric member 32 does not turn to the high compression ratio direction.

After that, at the time t2, the air-fuel mixture starts to be burned at the combustion chamber 7. Along with this, the engine speed NE rises. At this time, if setting the target engine speed to the normal idling speed NEnml, since the normal idling speed NEnml is lower than the reference speed NEbase, the eccentric member 32 does not turn. For this reason, the target engine speed in the idling state is set to a switching speed NEswit higher than the normal idling speed NEnml. As a result of this, the engine speed NE rises after the time t2 and reaches the switching speed NEswit at the time t4.

After the engine speed NE starts to rise at the time t2, if, at the time t3, the engine speed NE reaches the reference speed NEbase, the eccentric member 32 starts to turn, that is, the mechanical compression ratio MCR starts to be switched. After that, at the time t5, the mechanical compression ratio MCR finished being switched from the low compression ratio MCRlow to the high compression ratio MCRhigh. Note that, the flow direction switching mechanism 35 may be changed from the second state to the first state at a timing before the time t4 other than the previous time t1.

If, at the time t5, the mechanical compression ratio MCR finishes being switched, the target engine speed is set to the normal idling speed NEnml. As a result of this, the engine speed NE falls from the switching speed NEswit to the normal idling speed NEnml.

In the present embodiment, the target engine speed in the idling state is set higher than the normal idling speed NEnml, so right after startup of the internal combustion engine 1, the upward inertial force acting on the piston pin 21 becomes larger. As a result of this, the turning speed of the eccentric member 32 increases and the switching time of the mechanical compression ratio MCR is shortened. Therefore, in the present embodiment, right after startup of the internal combustion engine 1, the response when switching the mechanical compression ratio MCR from the low compression ratio MCRlow to the high compression ratio MCRhigh is improved.

<Control Routine of Compression Ratio Switching Processing at Startup>

Below, referring to the flow chart of FIG. 12, the switching control of the mechanical compression ratio MCR when switching of the mechanical compression ratio MCR is demanded right after startup of the internal combustion engine 1 will be explained in detail. FIG. 12 is a flow chart showing a control routine of processing for switching the compression ratio at the time of startup. The illustrated control routine is performed when the internal combustion engine 1 is started up. Before startup of the internal combustion engine 1, the mechanical compression ratio MCR is the low compression ratio MCRlow. Therefore, before startup of the internal combustion engine 1, the eccentric member 32 is in a state turned to the low compression ratio direction.

First, at step S101, it is judged if there is a demand for switching the mechanical compression ratio MCR, that is, a demand for turning of the eccentric member 32. If it is judged that there is no demand for switching of the mechanical compression ratio MCR, the routine proceeds to step S105. At step S105, the target engine speed NEt at the idling state is set to the normal idling speed NEnml. The normal idling speed NEnml is, for example, made 1200 rpm to 1500 rpm or so. After step S105, the control routine is ended without the mechanical compression ratio MCR being switched.

The case where there is no demand for switching the mechanical compression ratio MCR right after startup of the internal combustion engine 1 is, for example, the case where it is predicted that knocking would occur if switching the mechanical compression ratio MCR from the low compression ratio MCRlow to the high compression ratio MCRhigh right after startup of the internal combustion engine 1. The occurrence of any knocking is predicted based on a state before the startup of the internal combustion engine 1, for example, the outside air temperature, the water temperature of the internal combustion engine 1, etc. Specifically, if the outside air temperature or water temperature of the internal combustion engine 1 before startup of the internal combustion engine 1 is a predetermined knocking temperature or more, it is predicted that knocking will occur if switching the mechanical compression ratio MCR from the low compression ratio MCRlow to the high compression ratio MCRhigh right after startup of the internal combustion engine 1. Therefore, if it is predicted by the turning control means of the present embodiment based on a state before startup of the internal combustion engine 1 that knocking would occur if raising the mechanical compression ratio by making the eccentric member 32 turn in the high compression ratio direction, the turning control means does not allow the eccentric member 32 to turn to the high compression ratio direction right after startup of the internal combustion engine 1.

Further, even if it is predicted that the piston 5 and the intake valve 9 or the exhaust valve 12 would collide if switching the mechanical compression ratio MCR from the low compression ratio MCRlow to the high compression ratio MCRhigh right after startup of the internal combustion engine 1, switching of the mechanical compression ratio MCR is not demanded. Any collision is predicted based on a state before startup of the internal combustion engine 1, for example, the operating angles, phase angles (angles of centers of operating angles), valve lift amount, etc. of the intake valve 9 and the exhaust valve 12. Specifically, if the operating angle or valve lift amount of the intake valve 9 is a predetermined reference value or more before startup of the internal combustion engine 1, it is predicted that if switching the mechanical compression ratio MCR from the low compression ratio MCRlow to the high compression ratio MCRhigh, the piston 5 and the intake valve 9 will collide. In the same way, if the operating angle or valve lift amount of the exhaust valve 12 is a predetermined reference value or more before startup of the internal combustion engine 1, it is predicted that if switching the mechanical compression ratio MCR from the low compression ratio MCRlow to the high compression ratio MCRhigh, the piston 5 and the exhaust valve 12 will collide.

Further, if a crank angle between the phase angle of the intake valve 9 and top dead center of the compression stroke or top dead center of the exhaust stroke are predetermined reference angles or less before startup of the internal combustion engine 1, it is predicted that the piston 5 and the intake valve 9 would collide if switching the mechanical compression ratio MCR from the low compression ratio MCRlow to the high compression ratio MCRhigh. In the same way, if a crank angle between the phase angle of the exhaust valve 12 and top dead center of the compression stroke or top dead center of the exhaust stroke are predetermined reference angles or less before startup of the internal combustion engine 1, it is predicted that the piston 5 and the exhaust valve 12 would collide if switching the mechanical compression ratio MCR from the low compression ratio MCRlow to the high compression ratio MCRhigh. Therefore, if it is predicted that the piston 5 and the intake valve 9 or the exhaust valve 12 would collide if making the eccentric member 32 turn in the high compression ratio direction to raise the mechanical compression ratio, based on a state before startup of the internal combustion engine 1, the turning control means of the present embodiment does not turn the eccentric member 32 to the high compression ratio direction right after startup of the internal combustion engine 1.

On the other hand, when, at step S101, it is judged that there is a demand for switching the mechanical compression ratio MCR, the routine proceeds to step S102. At step S102, oil pressure is supplied from the hydraulic pressure feed source 75 to the switching pins 61 and 62 so that the flow direction switching mechanism 35 is changed from the second state to the first state. Due to this, flow of hydraulic oil from the second cylinder 34a to the first cylinder 33a is permitted.

Next, at step S103, the target engine speed NEt at the idling state is set to the switching speed NEswit higher than the normal idling speed NEnml.

Next, at step S104, it is judged if the mechanical compression ratio MCR has been switched from the low compression ratio MCRlow to the high compression ratio MCRhigh. This judgment is for example performed based on the height of the top surface of the piston 5 measured by a gap sensor (not shown). Further, this judgment may be performed based on the combustion pressure in the combustion chamber 7 measured by a combustion pressure sensor (not shown).

When, at step S104, it is judged that the mechanical compression ratio MCR has not been switched from the low compression ratio MCRlow to the high compression ratio MCRhigh, the routine returns to step S103. Therefore, the target engine speed NEt is set to the switching speed NEswit before the mechanical compression ratio MCR is switched from the low compression ratio MCRlow to the high compression ratio MCRhigh. Due to this, the response when switching the mechanical compression ratio MCR from the low compression ratio MCRlow to the high compression ratio MCRhigh can be improved.

At step S104, when it is judged that the mechanical compression ratio MCR has been switched from the low compression ratio MCRlow to the high compression ratio MCRhigh, the routine proceeds to step S105. At step S105, the mechanical compression ratio MCR finishes being switched, so the idle state target engine speed NEt is set to the normal idling speed NEnml. As a result of this, the engine speed NE falls from the switching speed NEswit to the normal idling speed NEnml. Due to this, it is possible to suppress deterioration of the fuel economy due to the engine speed NE being raised in the idling state. After step S105, the control routine ends.

Note that, the internal combustion engine 1 comprises an electronic control unit (ECU). All of the control of the control routine is performed by the ECU.

In this regard, if the oil temperature of the internal combustion engine 1 is low, the viscosity of the oil supplied from the hydraulic pressure feed source 75 to the switching pins 61 and 62 and the viscosity of the hydraulic oil held at either the first cylinder 33a or the second cylinder 34a will become higher. As a result of this, if the magnitude of the inertial force acting on the piston pin 21 is the same, the lower the oil temperature of the internal combustion engine 1, the worse the response when switching the mechanical compression from the low compression ratio to the high compression ratio. Therefore, in the present embodiment, the reference speed NEbase is set based on the oil temperature of the internal combustion engine 1, that is, the temperature of the hydraulic oil. Specifically, the reference speed NEbase is made higher when the oil temperature of the internal combustion engine 1 is relatively low compared to when the oil temperature is relatively high. In other words, the reference speed NEbase is made higher in steps or linearly as the oil temperature of the internal combustion engine 1 becomes lower. Due to this, it is possible to set the reference speed NEbase to a suitable speed corresponding to the oil temperature and possible to improve the response, regardless of the oil temperature, when switching the mechanical compression ratio from the low compression ratio to the high compression ratio.

### Second Embodiment

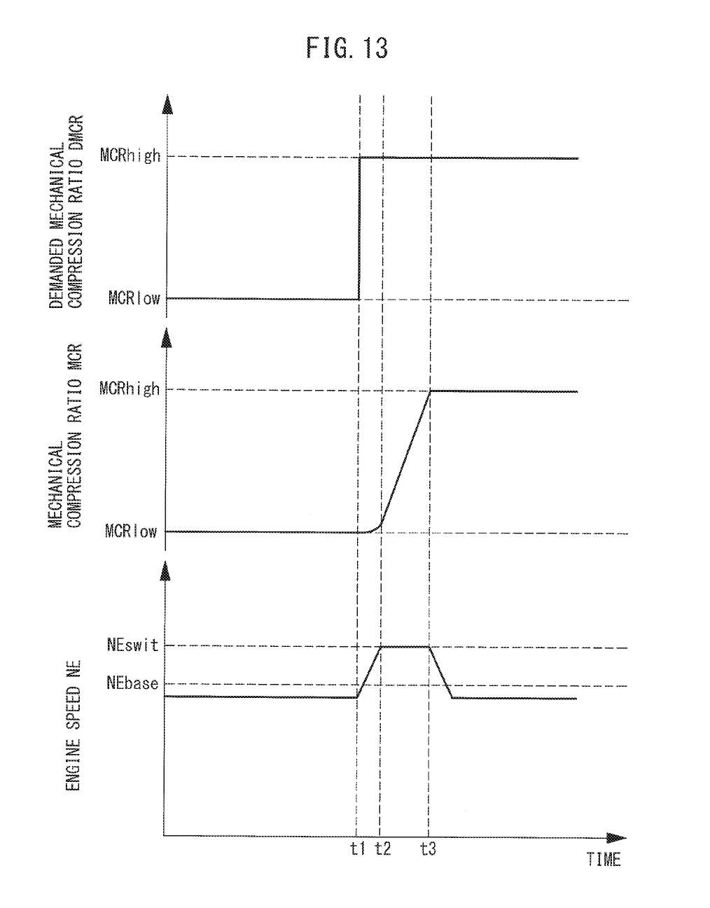

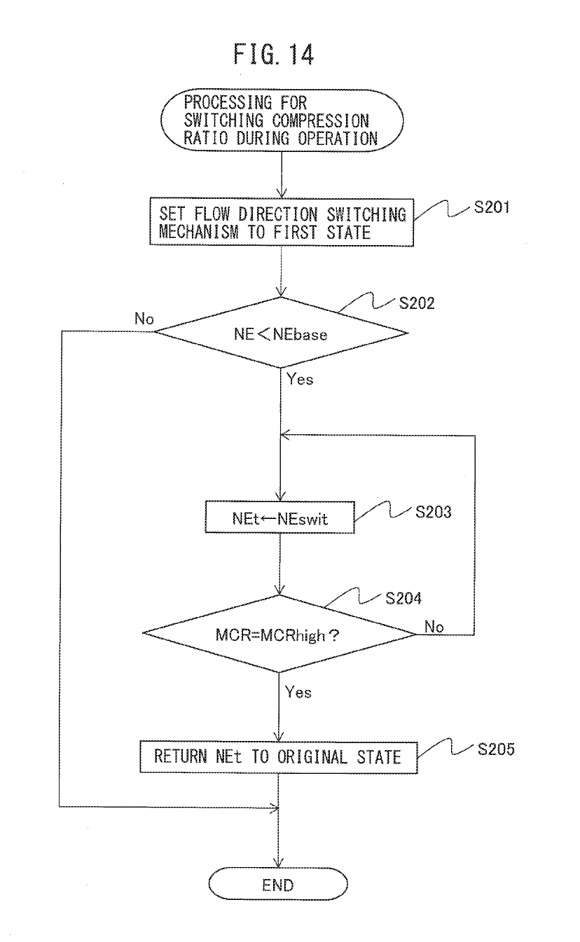

Next, referring to FIG. 13 and FIG. 14, a second embodiment of the present invention will be explained. Note that, the configuration and control of the internal combustion engine of the second embodiment are basically similar to the internal combustion engine of the first embodiment, so in the following explanation, mainly parts different from the first embodiment will be explained.

In the second embodiment of the present invention, the internal combustion engine 1 is mounted in a vehicle comprising a continuously variable transmission. The turning control means raises the engine speed to the reference speed or more if the engine speed is less than the reference speed when making the eccentric member 32 turn during operation of the vehicle. At this time, the continuously variable transmission changes the speed ratio in accordance with the rise of the engine speed so as to maintain the speed of the vehicle.

The reference speed is made a speed enabling the mechanical compression ratio to be switched from the low compression ratio to the high compression ratio or a speed enabling sufficient response to be secured when switching the mechanical compression ratio from the low compression ratio to the high compression ratio. The reference speed is, for example, made 1550 rpm to 2000 rpm or so and is made higher than the normal idling speed, for example, 1200 rpm to 1500 rpm.

<Time Chart of Switching of Mechanical Compression Ratio at Time of Vehicle Operation>

Below, referring to FIG. 13 and FIG. 14, this control will be specifically explained. FIG. 13 is a time chart of the demanded mechanical compression ratio DMCR, mechanical compression ratio MCR (actual mechanical compression ratio), and engine speed NE when switching of the mechanical compression ratio MCR is demanded during vehicle operation.

In the example of FIG. 13, at the time of vehicle operation before the time t1, the mechanical compression ratio MCR becomes a low compression ratio MCRlow. Therefore, at the time of vehicle operation before the time t1, the eccentric member 32 becomes a state turned to the low compression ratio direction.

In the example of FIG. 13, at the time t1, switching of the mechanical compression ratio MCR, that is, turning of the eccentric member 32, is demanded and the flow direction switching mechanism 35 is changed from the second state to the first state. Due to this, the flow of hydraulic oil from the second cylinder 34a to the first cylinder 33a is permitted.

In the example of FIG. 13, at the time t1, the engine speed NE is lower than the predetermined reference speed NEbase. Since the engine speed NE when turning of the eccentric member 32 is demanded is less than the reference speed NEbase, the target engine speed is set to a switching speed NEswit of the reference speed NEbase or more. As a result of this, the engine speed NE rises after the time t1 and reaches the switching speed NEswit at the time t2. While making the engine speed rise, to maintain the speed of the vehicle, the speed ratio of the continuously variable transmission is made to rise along with the rise of the engine speed. Due to this, when switching the mechanical compression ratio MCR from the low compression ratio MCRlow to the high compression ratio MCRhigh, even if making the engine speed rise, it is possible to maintain the speed of the vehicle during operation.

In the example of FIG. 13, after the time t1, the turning of the eccentric member 32, that is, the switching of the mechanical compression ratio MCR, is started. At the time t3, the mechanical compression ratio MCR finished being switched from the low compression ratio MCRlow to the high compression ratio MCRhigh. Note that, the flow direction switching mechanism 35 may also be changed from the second state to the first state at a timing from the time t1 to the time t2 other than the time t1.

If, at the time t3, the mechanical compression ratio MCR finishes being switched, the target engine speed is set to the engine speed before switching. As a result of this, the engine speed NE falls from the switching speed NEswit to the engine speed before switching. While the engine speed is made to fall, to maintain the speed of the vehicle, the speed ratio of the continuously variable transmission is lowered along with the drop in the engine speed. After the time t3, the engine speed NE is controlled in accordance with the operating state of the vehicle.

In the present embodiment, to make the eccentric member 32 turn, the target engine speed during vehicle operation is set to a switching speed NEswit of the reference speed NEbase or more, so the upward inertial force acting on the piston pin 21 becomes larger when making the eccentric member 32 turn. As a result of this, the turning speed of the eccentric member 32 increases and the switching time of the mechanical compression ratio MCR is shortened. Therefore, in the present embodiment, the response when switching the mechanical compression ratio MCR from the low compression ratio MCRlow to the high compression ratio MCRhigh during vehicle operation is improved.

<Control Routine of Compression Ratio Switching Processing at Time of Operation>

Below, referring to the flow chart of FIG. 14, the control for switching the mechanical compression ratio MCR when switching of the mechanical compression ratio MCR is demanded during vehicle operation will be explained in detail. FIG. 14 is a flow chart showing a control routine of processing for switching the compression ratio at the time of operation. The illustrated control routine is performed when switching of the mechanical compression ratio MCR from the low compression ratio MCRlow to the high compression ratio MCRhigh is demanded during vehicle operation. Therefore, before the start of this control routine, the mechanical compression ratio MCR is made the low compression ratio MCRlow and the eccentric member 32 is made a state turned to the low compression ratio direction.

First, at step S201, oil pressure is supplied from the hydraulic pressure feed source 75 to the switching pins 61 and 62 to make the flow direction switching mechanism 35 change from the second state to the first state. Due to this, the flow of hydraulic oil from the second cylinder 34a to the first cylinder 33a is permitted.

Next, at step S202, it is judged if the engine speed NE when turning of the eccentric member 32 is demanded is less than the reference speed NEbase. If it is judged that the engine speed NE when turning of the eccentric member 32 is demanded is the reference speed NEbas or more, the response when switching the mechanical compression ratio is secured, so the control routine is ended without the engine speed being changed.

On the other hand, if, at step S202, it is judged that the engine speed NE when turning of the eccentric member 32 is demanded is less than the reference speed NEbase, the routine proceeds to step S203.

At step S203, the target engine speed NEt during operation is set to the switching speed NEswit of the reference speed NEbase or more. Further, the speed ratio is made to change along with the rise of the engine speed so that the continuously variable transmission maintains the speed of the vehicle.

Next, at step S204, it is judged if the mechanical compression ratio MCR has been switched from the low compression ratio MCRlow to the high compression ratio MCRhigh. This judgment is performed based on the height of the top surface of the piston 5 measured by, for example, a gap sensor (not shown). Further, this judgment may be performed based on the combustion pressure in a combustion chamber 7 measured by a combustion pressure sensor (not shown).

When, at step S204, it is judged that the mechanical compression ratio MCR has not been switched from the low compression ratio MCRlow to the high compression ratio MCRhigh, the routine returns to step S203. Therefore, the target engine speed NEt is set to the switching speed NEswit until the mechanical compression ratio MCR is switched from the low compression ratio MCRlow to the high compression ratio MCRhigh. Due to this, it is possible to improve the response when switching the mechanical compression ratio MCR from the low compression ratio MCRlow to the high compression ratio MCRhigh.

When, at step S204, it is judged that mechanical compression ratio MCR has been switched from the low compression ratio MCRlow to the high compression ratio MCRhigh, the routine proceeds to step S205. At step S205, the mechanical compression ratio MCR finishes being switched, so the target engine speed NEt is set to the engine speed before the start of the control routine. As a result of this, the engine speed NE falls from the switching speed NEswit to the engine speed before the start of the control routine. Due to this, it is possible to suppress deterioration of the fuel economy due to raising the engine speed NE during vehicle operation. Note that, while lowering the engine speed, to maintain the speed of the vehicle, the speed ratio of the continuously variable transmission is lowered along with the drop in the engine speed. After step S205, the control routine ends.

Note that, the internal combustion engine 1 comprises an electronic control unit (ECU). All control of this control routine is performed by the ECU.

Further, in the second embodiment as well, the reference speed NEbase may be set based on the oil temperature of the internal combustion engine 1. Specifically, the reference speed NEbase is made higher when the oil temperature of the internal combustion engine 1 is relatively low compared with when the oil temperature is relatively high. In other words, the reference speed NEbase is made higher in steps or linearly as the oil temperature of the internal combustion engine 1 becomes lower. Due to this, the reference speed NEbase can be set to a suitable speed corresponding to the oil temperature. It is possible to improve the response when switching the mechanical compression ratio MCR from the low compression ratio MCRlow to the high compression ratio MCRhigh regardless of the oil temperature.

Above, suitable embodiments according to the present invention were explained, but the present invention is not limited to these embodiments and can be modified and changed in various ways within the language of the claims. For example, the switching control of the mechanical compression ratio in the first embodiment and the second embodiment of the present invention can also be applied when switching the mechanical compression ratio from the high compression ratio to the low compression ratio. Due to this, it is possible to improve the response when switching the mechanical compression ratio from the high compression ratio to the low compression ratio.

In this case, before demanding the switching of the mechanical compression ratio, the mechanical compression ratio becomes a high compression ratio and the eccentric member 32 is in a state turned to the high compression ratio direction. Further, in addition to the downward inertial force acting on the piston pin when switching the mechanical compression ratio from the high compression ratio to the low compression ratio, a downward explosive force acting on the piston pin due to combustion of the air-fuel mixture also assists turning of the eccentric member 32. For this reason, the reference speed in control for switching the mechanical compression ratio from the high compression ratio to the low compression ratio may be set lower than the reference speed in control for switching the mechanical compression ratio from the low compression ratio to the high compression ratio.

Further, as long as the hydraulic piston is configured to ascend in the hydraulic cylinder when the eccentric member 32 turns to one direction and to descend in the hydraulic cylinder when the eccentric member 32 turns in the other direction, the number of the piston mechanisms may be one. Further, the first embodiment and the second embodiment of the present invention can be combined.

### REFERENCE SIGNS LIST

1. internal combustion engine
5. piston
6. connecting rod
15. cylinder
21. piston pin
22. crankpin
31. connecting rod body
32. eccentric member
33. first piston mechanism
34. second piston mechanism
35. flow direction switching mechanism

1. A variable compression ratio internal combustion engine able to change a mechanical compression ratio, comprising a cylinder, a piston reciprocating inside the cylinder, and a connecting rod connected with the piston through a piston pin, wherein
the connecting rod comprises
a connecting rod body having a large diameter end part provided with a crank receiving opening receiving a crankpin and a small diameter end part positioned at the piston side at the opposite side from the large diameter end part, and
an eccentric member having a piston pin receiving opening receiving the piston pin and attached to the small diameter end part to be able to turn,
the eccentric member is configured so that an axis of the piston pin receiving opening becomes offset from a turning axis of the eccentric member and is configured so as to make the piston ascend with respect to the connecting rod body by turning in one direction and to make the piston descend with respect to the connecting rod body by turning in the other direction, and
the variable compression ratio internal combustion engine further comprises a turning control means for controlling turning of the eccentric member, the turning control means makes an engine speed a reference speed or more when making the eccentric member turn, and the reference speed being higher than an idling speed when not making the eccentric member turn.

2. The variable compression ratio internal combustion engine according to claim 1, wherein the eccentric member is in a state turned to the other direction before startup of the variable compression ratio internal combustion engine, and the turning control means makes the engine speed in the idling state rise to the reference speed or more when making the eccentric member turn to the one direction right after startup of the variable compression ratio internal combustion engine.

3. The variable compression ratio internal combustion engine according to claim 2, wherein if it is predicted based on a state before startup of the variable compression ratio internal combustion engine that knocking would occur if making the eccentric member turn to the one direction to thereby raise the mechanical compression ratio, the turning control means does not allow the eccentric member to turn to the one direction right after startup of the variable compression ratio internal combustion engine.

4. The variable compression ratio internal combustion engine according to claim 1, wherein the connecting rod further comprises a hydraulic cylinder provided at the connecting rod body and supplied with hydraulic oil, and a hydraulic piston sliding inside the hydraulic cylinder, the hydraulic piston is configured to ascend in the hydraulic cylinder when the eccentric member turns to the one direction and to descend in the hydraulic cylinder when the eccentric member turns in the other direction, and the reference speed is made higher when an oil temperature of the hydraulic oil is relatively low compared with when the oil temperature is relatively high.

5. The variable compression ratio internal combustion engine according to claim 2, wherein the connecting rod further comprises a hydraulic cylinder provided at the connecting rod body and supplied with hydraulic oil, and a hydraulic piston sliding inside the hydraulic cylinder, the hydraulic piston is configured to ascend in the hydraulic cylinder when the eccentric member turns to the one direction and to descend in the hydraulic cylinder when the eccentric member turns in the other direction, and the reference speed is made higher when an oil temperature of the hydraulic oil is relatively low compared with when the oil temperature is relatively high.

6. The variable compression ratio internal combustion engine according to claim 3, wherein the connecting rod further comprises a hydraulic cylinder provided at the connecting rod body and supplied with hydraulic oil, and a hydraulic piston sliding inside the hydraulic cylinder, the hydraulic piston is configured to ascend in the hydraulic cylinder when the eccentric member turns to the one direction and to descend in the hydraulic cylinder when the eccentric member turns in the other direction, and the reference speed is made higher when an oil temperature of the hydraulic oil is relatively low compared with when the oil temperature is relatively high.

7. The variable compression ratio internal combustion engine according to claim 1, wherein the variable compression ratio internal combustion engine is mounted in a vehicle comprising a continuously variable transmission, the turning control means makes an engine speed rise to the reference speed or more when making the eccentric member turn during operation of the vehicle and the engine speed is less than the reference speed, and the continuously variable transmission is made to change a speed ratio along with the rise in the engine speed so as to maintain the speed of the vehicle.

8. The variable compression ratio internal combustion engine according to claim 2, wherein the variable compression ratio internal combustion engine is mounted in a vehicle comprising a continuously variable transmission, the turning control means makes an engine speed rise to the reference speed or more when making the eccentric member turn during operation of the vehicle and the engine speed is less than the reference speed, and the continuously variable transmission is made to change a speed ratio along with the rise in the engine speed so as to maintain the speed of the vehicle.

9. The variable compression ratio internal combustion engine according to claim 3, wherein the variable compression ratio internal combustion engine is mounted in a vehicle comprising a continuously variable transmission, the turning control means makes an engine speed rise to the reference speed or more when making the eccentric member turn during operation of the vehicle and the engine speed is less than the reference speed, and the continuously variable transmission is made to change a speed ratio along with the rise in the engine speed so as to maintain the speed of the vehicle.

10. The variable compression ratio internal combustion engine according to claim 4, wherein the variable compression ratio internal combustion engine is mounted in a vehicle comprising a continuously variable transmission, the turning control means makes an engine speed rise to the reference speed or more when making the eccentric member turn during operation of the vehicle and the engine speed is less than the reference speed, and the continuously variable transmission is made to change a speed ratio along with the rise in the engine speed so as to maintain the speed of the vehicle.

11. The variable compression ratio internal combustion engine according to claim 5, wherein the variable compression ratio internal combustion engine is mounted in a vehicle comprising a continuously variable transmission, the turning control means makes an engine speed rise to the reference speed or more when making the eccentric member turn during operation of the vehicle and the engine speed is less than the reference speed, and the continuously variable transmission is made to change a speed ratio along with the rise in the engine speed so as to maintain the speed of the vehicle.

12. The variable compression ratio internal combustion engine according to claim 6, wherein the variable compression ratio internal combustion engine is mounted in a vehicle comprising a continuously variable transmission, the turning control means makes an engine speed rise to the reference speed or more when making the eccentric member turn during operation of the vehicle and the engine speed is less than the reference speed, and the continuously variable transmission is made to change a speed ratio along with the rise in the engine speed so as to maintain the speed of the vehicle.
